(19) United States
(12) Patent Application Publication
(10) Pub. No.: US 2025/0387745 A1
(43) Pub. Date: Dec. 25, 2025

(54) DYNAMIC WATER SPRINKLER SYSTEM FOR AIRBORNE PARTICLE CONTROL

(71) Applicant: SAUDI ARABIAN OIL COMPANY, Dhahran (SA)

(72) Inventor: Fawaz Abdulqadir AL-WOHAIB, Dhahran (SA)

(73) Assignee: SAUDI ARABIAN OIL COMPANY, Dhahran (SA)

(21) Appl. No.: 18/751,962

(22) Filed: Jun. 24, 2024

(51) Int. Cl. B01D 47/06; G05B 13/02

(52) U.S. Cl. CPC B01D 47/06; G05B 13/026

(57) ABSTRACT

A sprinkler system is disclosed comprising a plurality of sprinklers, a sensor to measure a parameter of airborne particles, and a controller in communication with the sprinklers and the sensor. Each sprinkler comprises a nozzle and is transitionable between a first state in which the nozzle abstains from spraying fluid and a second state in which the nozzle sprays fluid. The controller is to receive, from the sensor, a value of the parameter of airborne particles and selectively transition at least one of the plurality of sprinklers from the first state to the second state based on the value of the parameter.

### FIELD OF THE DISCLOSURE

The present disclosure relates generally to water sprinkler systems and, more particularly, to a dynamic water sprinkler system for suppressing airborne particles and ambient particulate matter.

### BACKGROUND OF THE DISCLOSURE

In urban and industrial environments, airborne particles (e.g., pollution, dust, pollen, etc.) pose a significant threat to public health and environmental sustainability. Traditional methods of pollution control often rely on systems with limited adaptability and efficiency. These systems are typically static in nature and lack the ability to respond dynamically (adapt) to changing pollution patterns and environmental conditions. As a result, they may be ineffective in adequately suppressing pollution hotspots, leading to continued environmental degradation and public health risks.

Water sprinkler systems have been conventionally used for various purposes, including irrigation and fire suppression. These systems typically operate based on fixed parameters, like a fixed schedule (time and duration) and fixed flow rates, and are not specifically designed for automated pollution control purposes. Existing water sprinkler systems may lack the sophistication required to harness real-time data from environmental forecasts for adaptive control.

Accordingly, there is a need for a dynamic water sprinkler system that effectively targets and combats air pollution while simultaneously restricting water usage.

### SUMMARY OF THE DISCLOSURE

Various details of the present disclosure are hereinafter summarized to provide a basic understanding. This summary is not an extensive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

In various embodiments, a sprinkler system is disclosed including a plurality of sprinklers, a sensor to measure a parameter of airborne particles, and a controller in communication with the sprinklers and the sensor. Each sprinkler comprises a nozzle and is transitionable between a first state in which the nozzle abstains from spraying fluid and a second state in which the nozzle sprays fluid. The controller is to receive, from the sensor, a value of the parameter of airborne particles and selectively transition at least one of the plurality of sprinklers from the first state to the second state based on the value of the parameter.

In various embodiments, a method is disclosed including sensing, with a sensor, a parameter of airborne particles and selectively transitioning, with a controller, a plurality of sprinklers from a first state to a second state based on a value of the parameter of airborne particles. In the first state, a nozzle of at least one of the plurality of sprinklers abstains from spraying a fluid. In the second state, the nozzle of the at least one of the plurality of sprinklers sprays a fluid.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 illustrates an example sprinkler in accordance with at least one aspect of the present disclosure.

FIG. 2 is a top-down view of the sprinkler of FIG. 1, in accordance with at least one aspect of the present disclosure.

FIG. 3 illustrates an example sprinkler system including a plurality of the sprinklers of FIG. 1, in accordance with at least one aspect of the present disclosure.

FIG. 4 is an alternative arrangement of the sprinkler system of FIG. 3, in accordance with at least one aspect of the present disclosure.

FIGS. 5A-5C illustrate a first example implementation of the sprinkler system of FIG. 3, in accordance with at least one aspect of the present disclosure.

FIGS. 6A-6C are a second example implementation of the sprinkler system of FIG. 3, in accordance with at least one aspect of the present disclosure.

FIG. 7 is a method, in accordance with at least one aspect of the present disclosure.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Embodiments in accordance with the present disclosure generally relate to water sprinkler systems and, more particularly, to a dynamic water sprinkler system for suppressing airborne particles and ambient particulate matter. More specifically, the present disclosure provides a dynamic water sprinkler system for airborne particle (pollution) control. The water sprinkler system in accordance with the present disclosure combines advanced technology and environmental consciousness to combat outdoor air pollution dynamically. Beneficially, the water sprinkler system of the present disclosure exhibits substantial suppression of ambient airborne particles between 0.01 to 10 microns, displays significant reduction in water usage without compromising on air quality improvement outcomes by intelligently manipulating water distribution profiles in line with particulate cloud movement, and creates a positive impact on surrounding vegetation growth.

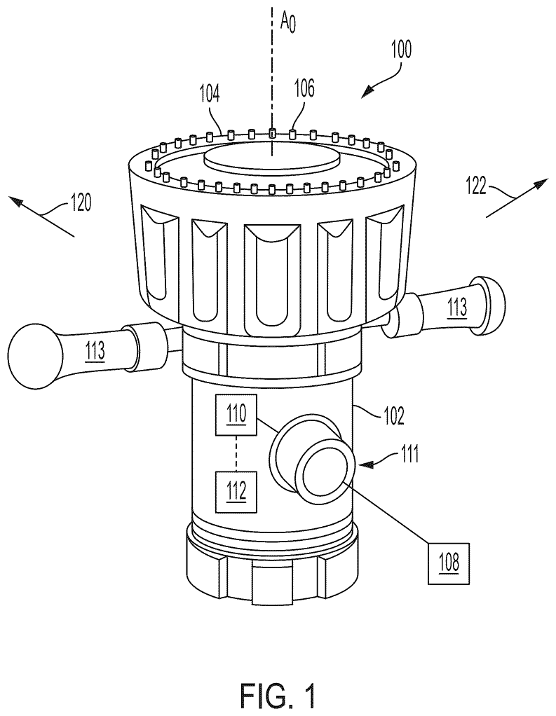

FIG. 1 illustrates an example sprinkler 100, according to at least one aspect of the present disclosure. As illustrated, the sprinkler 100 includes a base 102 and a head 104 operatively coupled to and extending from the base 102. The head 104 includes a plurality of nozzles 106 to convey a fluid from a fluid source 108 therethrough and toward, for example, airborne particles (pollution) to be suppressed. In some embodiments, the nozzles 106 comprise atomizing nozzles configured to generate water droplets with a mean diameter within the range of 20-50 microns. Droplets at this size range facilitate efficient scavenging of airborne particulates between 0.01 to 10 microns via diffusion, interception, and inertial impact.

In some embodiments, the sprinkler 100 further comprises an electronically-actuatable control valve 110 and an inlet conduit 111 fluidically coupled to the control valve 110 and fluidically couplable to the fluid source 108. The control valve 110 (and thus, the sprinkler 100) is transitionable between a plurality of states to regulate the flow of fluid (water, for example) from the fluid source 108, through the inlet conduit 111, and to the nozzles 106. For instance, in some embodiments, the sprinkler 100 is transitionable between a closed state in which no fluid flows through the control valve 110 (e.g., the sprinkler 100 abstains from spraying fluid through the nozzles 106), a first open state in which the control valve 110 permits a first rate of fluid flow therethrough (e.g., the sprinkler 100 discharges fluid from the nozzles 106 at a first rate), and a second open state in which the control valve 110 permits a second rate of fluid flow therethrough that is greater than the first rate of fluid flow (e.g., the sprinkler 100 discharges fluid from the nozzles 106 at a second rate greater than the first rate). In some embodiments, in the first open state, the control valve 110 is partially open (25%, 50%, or 75% open, for example) and, in the second open state, the control valve 110 is fully open (100% open). While two open states are described, it should be understood that the control valve 110 (and thus, the sprinkler 100) can be transitioned into more than two open states, such as three, four, or five open states with each state having different rates of fluid flow therethrough.

In some embodiments, the control valve 110 comprises a solenoid valve actuatable to manipulate the orientation (position) of an internal valve member. In some embodiments, the control valve 110 includes a valve such as, but not limited to, a gate valve, a globe valve, a ball valve, or a butterfly valve, for example). The control valve 110 also includes an electric actuator (e.g., a motor) coupled to the valve to transition the valve between the closed and open states. In some embodiments, the control valve 110 may be configured to modulate water pressures between 50-120 psi. In some embodiments, the sprinkler 100 further comprises a sprinkler controller 112 communicably coupled (such as wireless or wirelessly) to the control valve 110 and operable to control a state of the control valve 110.

In some embodiments, the head 104 is rotatably coupled to the base 102 such that the head 104 can rotate between a plurality of angular orientations to obtain a desired spray trajectory. For example, in some embodiments, the head 104 can be coupled to the base 102 with a ball-and-socket arrangement to allow the head 104 to rotate between a first orientation, in which head 104 (and thus, the nozzle 106) faces a first direction 120 away from the base 102, and a second orientation, in which head 104 (and thus, the nozzle 106) faces a second direction 122 away from the base 102 that is different from the first direction 102. In such embodiments, the sprinkler 100 includes an actuator (such as a motor and cables tensionable by the motor, for example) to move the head 104 between the plurality of orientations. In some embodiments, the first and second directions 120, 122 are in the same plane. In some embodiments, the first and second directions 120, 122 are in different planes.

In some embodiments, a central axis extends through the sprinkler 100 and the head 104 is rotatably coupled to the base 102 in a manner that permits the head 104 to rotate about the central axis Ao into the plurality of orientations. In some embodiments, the sprinkler 100 includes an actuator (such as a motor, for example) to move (rotate) the head 104 between the plurality of orientations. In some embodiments, the motor rotates the head 104 at a plurality of speeds, such as a first non-zero speed and a second non-zero speed greater than the first non-zero speed. Rotating the head 104 at varying speeds allows the nozzles 106 to spray varying spray patterns (bigger area when rotated faster, for example). In some embodiments, the sprinkler 100 includes handles 113 that permits a user to manually move the sprinkler 100 between the plurality of orientations.

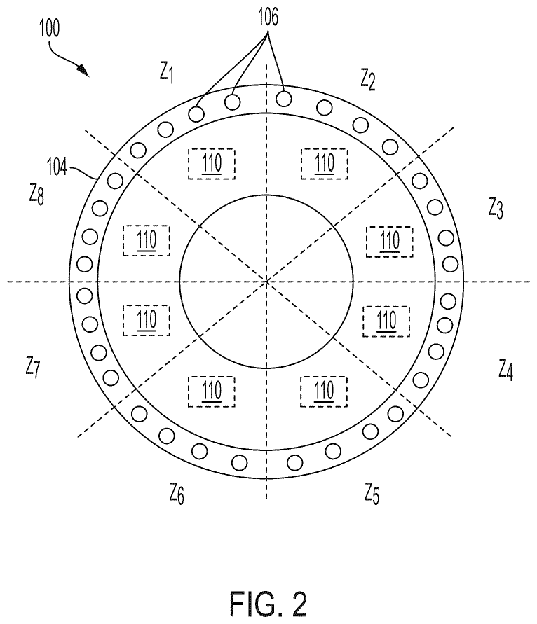

Referring now to FIG. 2, illustrated is a schematic, top view of the sprinkler 100, according to one or more embodiments. As illustrated, the head 104 may define a plurality of zones Z₁₋₈, where each zone Z₁₋₈ comprises a subset of the nozzles 106. In some embodiments, the sprinkler 100 may include a plurality of control valves 110 (as opposed to just one control valve 110) that are each fluidically coupled to the fluid source 108 (FIG. 1) and a corresponding subset of the nozzles 106 to control a flow rate of fluid to the subset of nozzles 106. In such arrangements, the sprinkler controller 112 (FIG. 1) can selectively transition the control valves 110 between the closed and open states to spray fluid from none, some, or all of the zones Z₁₋₈ according to a desired spray trajectory. While 8 zones Z₁₋₈ are shown, in other embodiments, the head 104 can define fewer (two, four, or six zones, for example) or more zones (ten, twelve, or fourteen zones, for example).

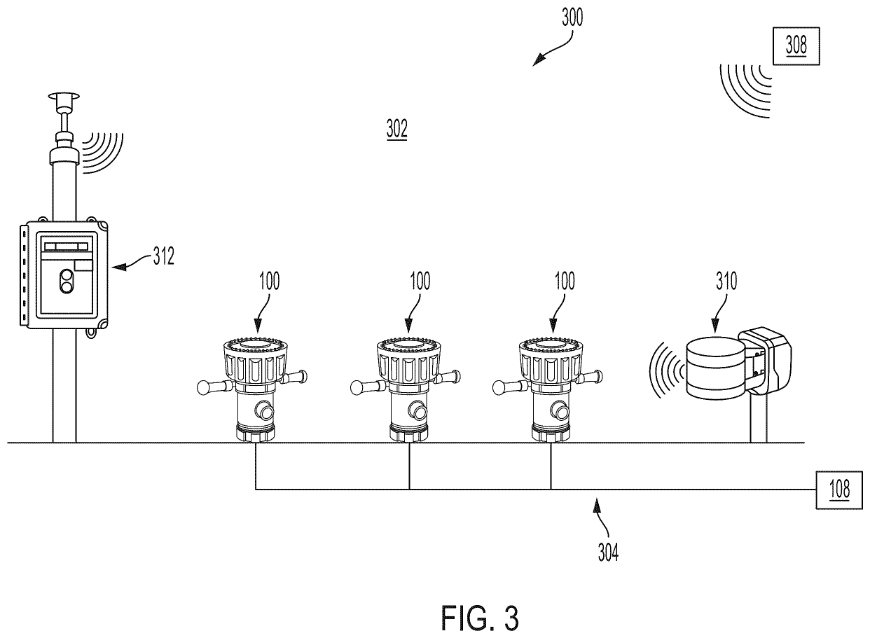

FIG. 3 is an example dynamic sprinkler system 300, according to at least one aspect of the present disclosure. The sprinkler system 300 comprises a plurality of the sprinklers 100 positioned (mounted) in the ground in an area 302 that requires airborne particle (pollution) control from a pollution source (e.g., construction dust, dust clouds, vehicle emissions, stationary power generator emissions, other industrial and agricultural emissions, residential heating and cooking emissions, re-emission from terrestrial and aquatic surfaces, as examples). As used herein, the term “construction dust” refers to tiny particles of silica, a common mineral found in materials such as sand, stone, concrete, and mortar, that can be inhaled and pose health risk. While only three sprinklers 100 are shown, the sprinkler system 300 can comprise fewer than three sprinklers 100 (such as one or two) or more than three sprinklers 100 (such as four, five, for six, for example). In some embodiments, each of the sprinklers 100 are fluidically coupled to the same fluid source 108 via an underground fluid line 304 to receive a fluid therefrom. In some embodiments, the fluid source 108 comprises a water tank (sweet water or treated raw water), treated ground water, or treated sewage effluent, or combinations thereof.

In some embodiments, the sprinklers 100 are positioned relative to one another in the area 302 such that, when the sprinklers 100 are in an open state (such as the first or second open states), the fluid sprayed (discharged) from the nozzles 106 do not overlap, or do not substantially overlap, one another. Accordingly, in such embodiments, each of the sprinklers 100 are positioned to spray (distribute) fluid within discrete portions of the area 302 to target airborne particles. In other embodiments, the sprinklers 100 are positioned relative to one another in the area 302 such that, when the sprinklers 100 are in the open state, the fluid sprayed from the nozzles 106 overlap one another. Accordingly, in such embodiments, two or more sprinklers 100 can co-operatively spray (distribute) fluid within a discrete portion of the area 302 to co-operatively target airborne particles.

In some embodiments, the system 300 further comprises one or more sensors for measuring parameters of the airborne particles and a system controller 308 in communication with the sensors and the sprinkler controllers 112 (FIG. 1). The system controller 308 can receive measurements from the sensors and selectively control the sprinklers 100 based on the measured parameters. In some embodiments, the system controller 308 comprises a cloud-based system or a local controller. In some embodiments, the system controller 308 includes a processor and a memory storing computer-readable instructions that are executable by the processor to carry out the various operations described herein. In some embodiments, the memory stores various sensor measurement thresholds and/or threshold ranges for determining when to transition the various sprinklers 100 between the open/closed states, what orientation to position the sprinklers 100, and for how long to maintain the sprinklers 100 in the open state before transitioning the sprinklers 100 back to a closed state.

In some embodiments, the sensors are placed in discrete locations around the area 302. In some embodiments, the sensors are placed adjacent to a subset of the sprinklers 100 (such as one, two, or three sprinklers 100, for example) such that each sensor senses/detects parameters of the airborne particles adjacent to the subset of sprinklers 100. Accordingly, in some such embodiments, the system controller 308 can selectively actuate a subset of sprinklers 100 according to the sensed parameters local (adjacent) to the subset of sprinklers 100. In some embodiments, the system controller 308 can determine airborne particle movement within the area 302 in order to determine which of the sprinklers 100 to selectively actuate. In some embodiments, the system controller 308 can use machine learning algorithms to selectively actuate and/or position the sprinklers 100 based on the measurements from the sensors.

In some embodiments, the sensors comprise one or more air quality sensors 310 to continuously (or intermittently) sense the airborne particles (such as PM2.5, PM10, NOx, for example) within the area 302. In some embodiments, the air quality sensors 310 comprise optical sensors, such as nephelometers or tapered element oscillating microbalances (TEOMs), for example, to measure and/or detect transient airborne particle hotspots within the area 302. In some embodiments, the air quality sensors 310 comprise a volatile organic compound (VOC) sensor, a particulate matter (PM) sensor, or a carbon monoxide (CO) sensor, or combinations thereof.

In various embodiments, the system controller 308 compares the values of the various sensor readings (measurements) to the sensor thresholds/threshold ranges stored in the memory. Based on the comparison, the system controller 308 can selectively orient and/or actuate some or all the sprinklers 100 to suppress airborne particles in the area 302. As one example, an air quality sensor may sense one or more parameters in the area 302, such as a concentration of airborne particles (e.g., a dust cloud). The system 308 controller can receive the value of this parameter and compare the same to a concentration threshold. Based on the threshold approaching, reaching, or exceeding an upper threshold, the system controller 308 can selectively transition (actuate) a subset, or all, of the sprinklers 100 to an open state to spray (discharge a fluid into) the airborne particles. In some embodiments, the amount of time the sprinklers 100 remain in the open state can be a predetermined time, or can be based on the value of the sensed parameter approaching, reaching, or dropping below a lower threshold.

In some embodiments, the system controller 308 can further receive meteorological data (inputs) and selectively control the sprinklers 100 further based on this data. For example, in some embodiments, the system 300 comprises an environmental sensor 312 to sense environmental parameters of the area 302. In some embodiments, the environmental sensor 312 comprises a LIDAR sensor to measure the direction and intensity of wind in the area 302, which can correspond to movement of airborne particles within the area 302. In some embodiments, the environmental sensor 312 comprises an anemometer, a wind direction sensor, a temperature sensor, or a humidity sensor, doppler radar, or combinations thereof, which can provide additional data to the system controller 300. The system controller 300 can utilize this environmental data alone, or in combination with the various other sensors described herein, such as the air quality sensors 310, to control the sprinklers 100. In some embodiments, the meteorological data can comprise weather forecasts, and the system controller 308 can utilize the meteorological data to determine what direction to orient the sprinklers 100. For example, the system controller 308 can receive data from a wind sensor or doppler radar to determine the flow path of airborne particles within the area 302. Based on the received data, the system controller 308 can orient the sprinklers 100 according to the movement of the airborne particles within the area 302.

In some embodiments, the system controller 308 can forecast (predict) airborne particle migration using historical trends, weather forecasts, or airborne particle release simulations, or combinations thereof. Based on the predictions, the system controller 308 can control the sprinklers 100. For example, in one instance, the system controller 308 may predict an influx of airborne particles from the west of the area 302 and preemptively orient one or more of the sprinklers 100 toward the oncoming airborne particles (westward).

The foregoing sprinkler system 300 provides a closed-loop, dynamic system that can use some combination of real-time data, meteorological data, and predictive data to provide control over the ambient air quality using the sprinklers 100. The sprinkler system 300 can selectively control the fluid flow, fluid pressure, and orientation (spray trajectory) of the sprinklers 100 according to the received data, as opposed to merely turning on sprinklers 100 when ambient air quality control in an area 302 is required. The selective control over the sprinklers 100 allows for a selective targeting of airborne particle (pollution) hotspots and reduces water usage, which is particularly beneficial in areas where water is a valuable commodity. The sprinkler system 300 further creates a positive impact on surrounding vegetation growth pattern and effective photosynthesis.

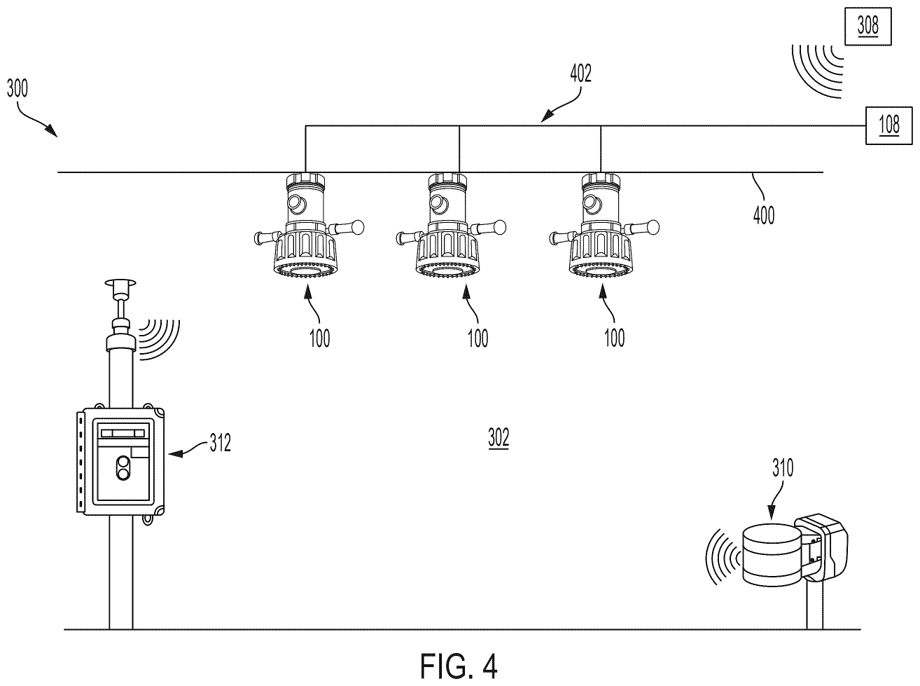

FIG. 4 is an alternative arrangement of the water sprinkler system of FIG. 3, in accordance with at least one aspect of the present disclosure. The arrangement in FIG. 4 is substantially the same as the arrangement in FIG. 3. However, as shown in FIG. 4, the sprinklers 100 can be mounted to an elevated or “upper” structure 400, such as the roof of a building, for example, and can receive fluid from the fluid source 108 via a piping arrangement 402 within the upper structure 400. In another embodiment, the upper structure 400 comprises a fence that surrounds the area 302, and the fence can have a range of heights necessary to properly function.

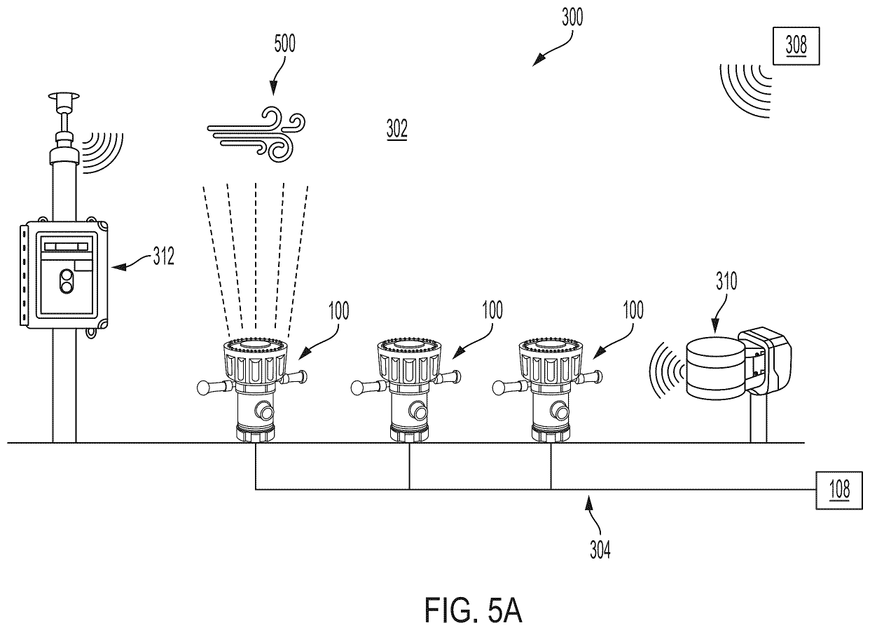

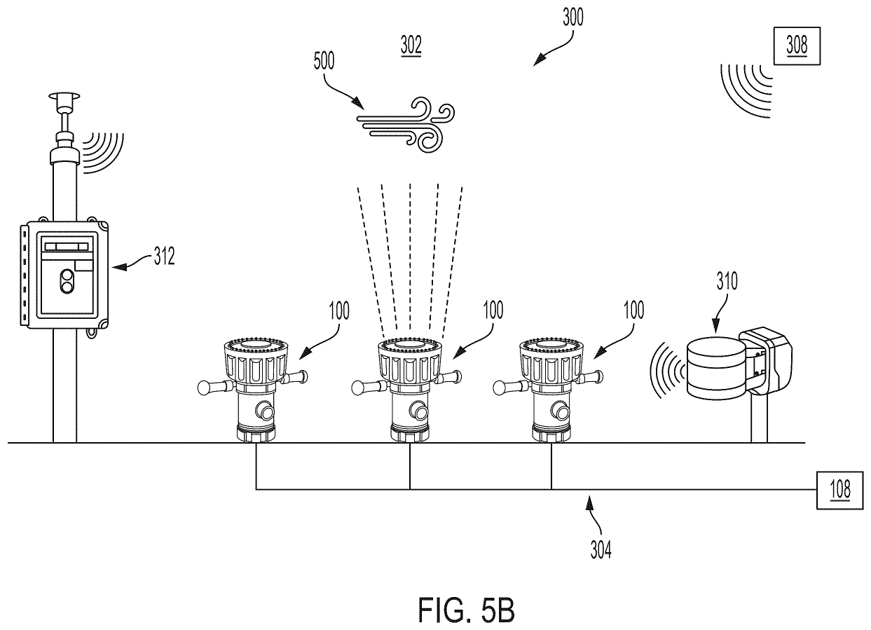

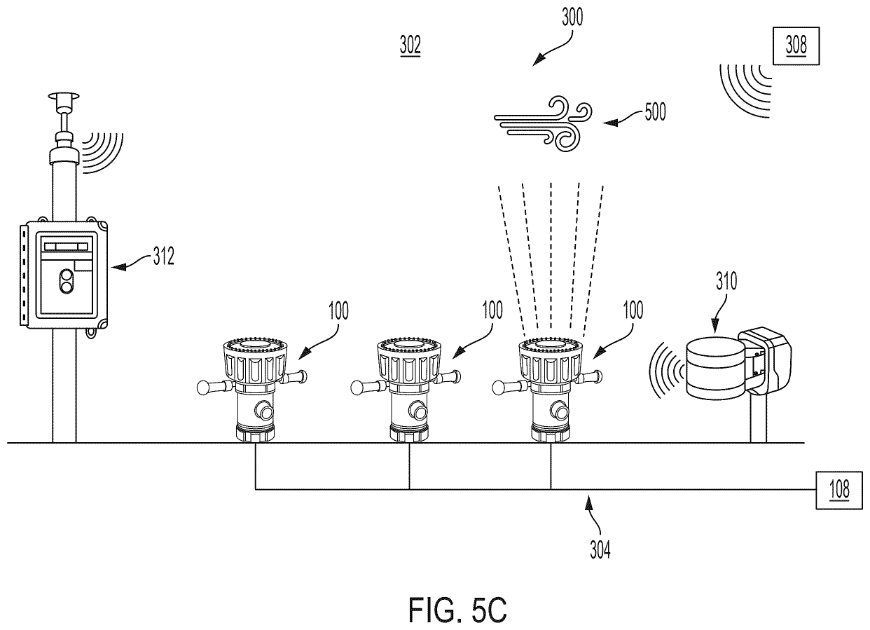

FIGS. 5A-5C illustrate a first example implementation of the sprinkler system of FIG. 3, in accordance with at least one aspect of the present disclosure. As shown in FIG. 5A, airborne particles (e.g., pollution, a dust cloud, etc.) 500 enter the area 302. The system controller 308 receives data from the various sensors of the system 300 (air quality sensor 310, environmental sensor 312, etc.) to determine which of the sprinklers 100 to selectively actuate (transition from a closed state to an open state). Based on the values of the measured parameters, the system controller 308 can selectively transition the sprinklers 100 between the off and on states as the airborne particles 500 move through the area 302, as shown in the transition from FIG. 5A to FIG. 5C.

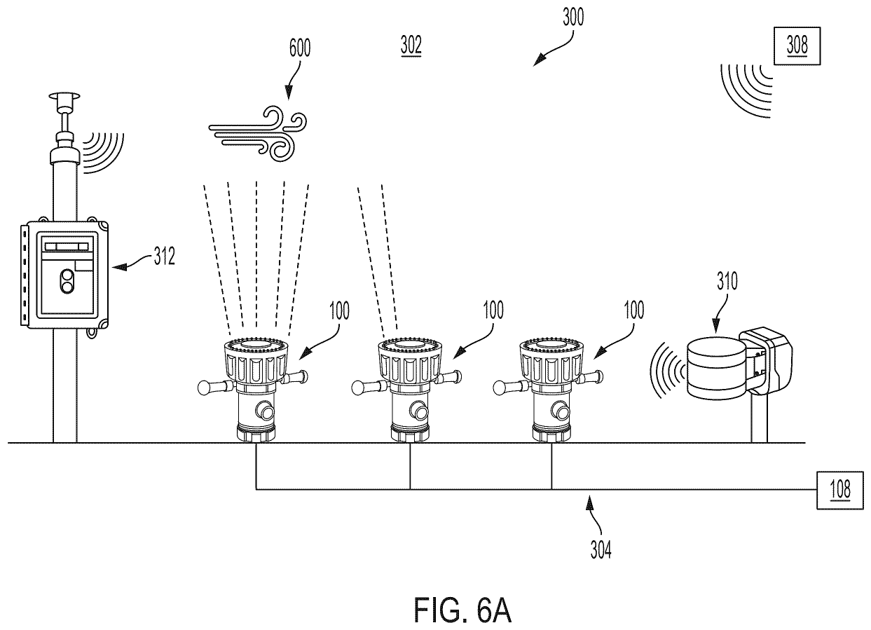

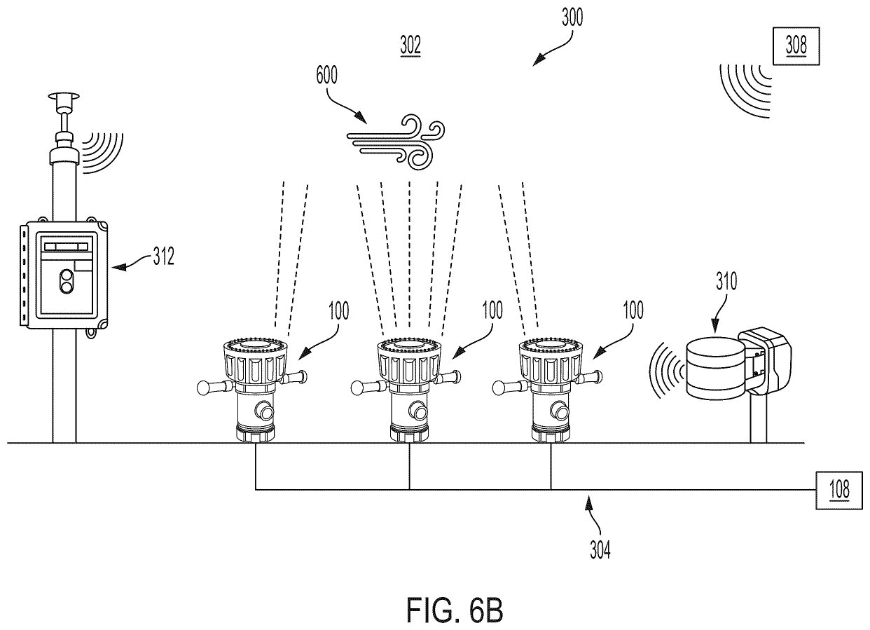

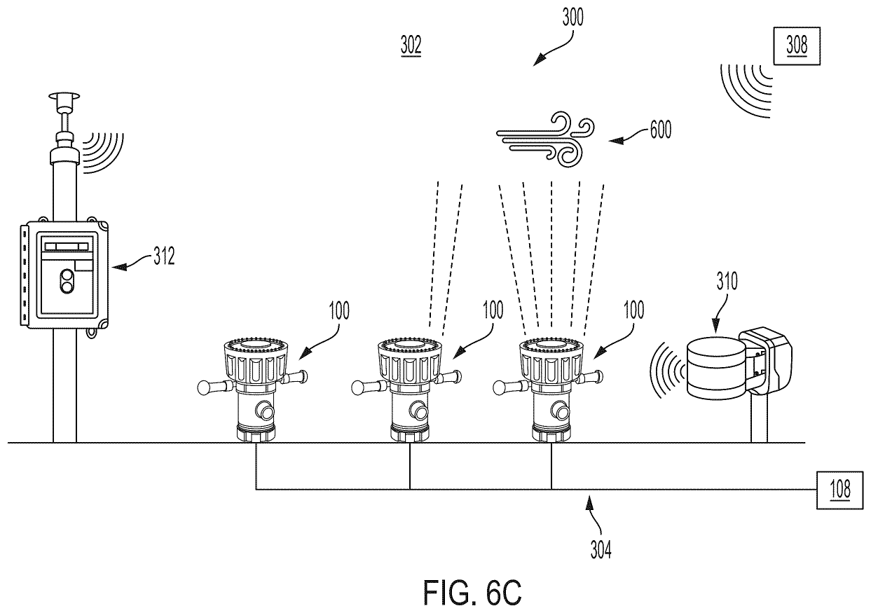

FIGS. 6A-6C illustrate a second example implementation of the sprinkler system of FIG. 3, in accordance with at least one aspect of the present disclosure. As shown in FIG. 6A, airborne particles (e.g., pollution, a dust cloud, etc.) 600 enter the area 302. The system controller 308 receives data from the various sensors of the system 300 (air quality sensor 310, environmental sensor 312, etc.) to determine which of the sprinklers 100 to selectively actuate (transition from a closed state to an open state). Similar to the example in FIGS. 5A-5C, and based on the values of the measured parameters, the system controller 308 can selectively transition the sprinklers 100 between the off and on states as the airborne particles 600 move through the area 302.

In addition, the system controller 308 can control the orientation of the sprinklers 100. For example, as shown in FIG. 6A, the system controller 308 can control an orientation of the middle sprinkler 100 such that the left and middle sprinklers 100 co-operatively spray the airborne particles 600. Similarly, as shown in FIG. 6B, the system controller 308 can control an orientation of the left and right sprinklers 100 such that all three sprinklers co-operatively spray the airborne particles 600.

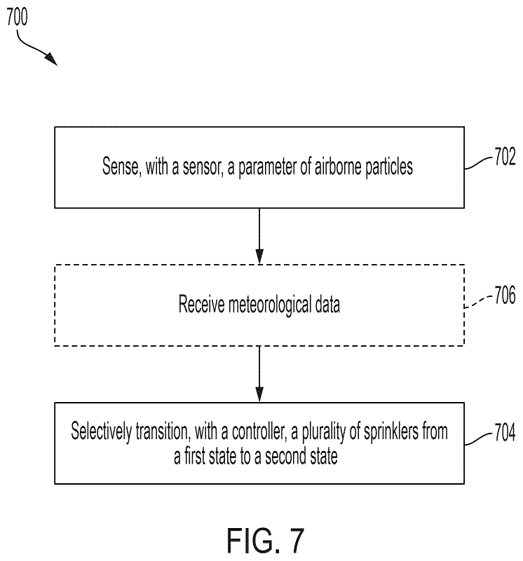

FIG. 7 is a schematic flowchart of an example method 700 of suppressing airborne particles, according to at least one aspect of the present disclosure. The method 700 includes sensing, with a sensor, a parameter of airborne particles, as at 702. In some aspects, a sensor, such as an air quality sensor 310, can sense one or more parameters of airborne particles within an area, such as area 302.

The method 700 further includes selectively transitioning, with a controller, a plurality of sprinklers from a first state to a second state, as at 704. In some aspects, a controller, such as system controller 308, can receive values of the one or more parameters sensed by the sensors. Based on the values of the one or more parameters (such as the values of the parameters approaching, reaching, or exceeding a threshold), the controller can selectively transition one or more sprinklers, such as sprinklers 100, from a closed state to an open state to spray (discharge) a fluid at the airborne particles. In some aspects, the controller (system controller 308) can control the sprinklers by communicating (wired or wirelessly) with sprinkler controllers (sprinkler controllers 112) of to the sprinklers. The sprinkler controllers, based on the communication, can selectively control valves of the sprinklers (control valves 110) to regulate a fluid flow from the sprinklers 100 toward the airborne particles.

The method 700 optionally further includes receiving meteorological data and selectively transitioning the sprinklers from the first state to the second state further based on the received meteorological data, as at 706. In some aspects, the system controller can receive meteorological data (weather forecasts, LIDAR sensor data, anemometer data, wind direction data, temperature or humidity data, or combinations thereof). Based on this receive data, the controller can determine which of the sprinklers to selectively transition from the first state to the second state and/or what direction to orient the sprinklers.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation are used herein merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such.

The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than the broadest meaning understood by skilled artisans, such a special or clarifying definition will be expressly set forth in the specification in a definitional manner that provides the special or clarifying definition for the term or phrase. It must also be noted that, as used in the specification and the appended claims, the singular forms “a,” “an,” and “the” include plural references unless otherwise specified.

For example, the following discussion contains a non-exhaustive list of definitions of several specific terms used in this disclosure (other terms may be defined or clarified in a definitional manner elsewhere herein). These definitions are intended to clarify the meanings of the terms used herein. It is believed that the terms are used in a manner consistent with their ordinary meaning, but the definitions are nonetheless specified here for clarity.

As used in this specification and the claims, the terms “comprising,” “containing,” or “including” mean that at least the named compound, element, material, particle, or method step is present in the composition, the article, or the method, but does not exclude the presence of other compounds, elements, materials, particles, or method steps even if the other such compounds, elements, materials, particles, or method steps have the same function as that which is named, unless expressly excluded in the claims. It is also to be understood that the mention of one or more method steps does not preclude the presence of additional method steps before or after the combined recited steps or intervening method steps between those steps expressly identified.

Moreover, it is also to be understood that the lettering of process steps or ingredients is for identifying discrete activities or ingredients and the recited lettering can be arranged in any sequence, unless expressly indicated.

For the purpose of the present description and of the claims which follow, except where otherwise indicated, numbers expressing amounts, quantities, percentages, and so forth, are to be understood as being modified by the term “about”. Also, ranges include any combination of the maximum and minimum points disclosed and include any intermediate ranges therein, which may or may not be specifically enumerated herein.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

The invention claimed is:

1. A sprinkler system, comprising:
a plurality of sprinklers, wherein each sprinkler comprises a nozzle and is transitionable between:
a first state in which the nozzle abstains from spraying fluid; and
a second state in which the nozzle sprays fluid;
a sensor to measure a parameter of airborne particles; and
a controller in communication with the sprinklers and the sensor to:
receive, from the sensor, a value of the parameter of airborne particles; and
selectively transition at least one of the plurality of sprinklers from the first state to the second state based on the value of the parameter.

2. The sprinkler system of claim 1, wherein:
in the first state, the nozzle sprays fluid at a first rate;
each sprinkler is further transitionable into a third state in which the nozzle sprays fluid at a second rate different from the first rate; and
the controller selectively transitions the at least one of the plurality of sprinklers from the first or second state to the third state based on the value of the parameter of airborne particles.

3. The sprinkler system of claim 1, wherein selectively transitioning the at least one of the plurality of sprinklers from the first state to the second state comprises selectively transitioning the at least one of the plurality of sprinklers from the first state to the second state based on the value of the parameter of airborne particles and a threshold.

4. The sprinkler system of claim 1, wherein the sensor comprises an optical sensor.

5. The sprinkler system of claim 1, wherein the controller is further to receive meteorological data, and wherein the controller is to selectively transition the sprinklers from the first state to the second state further based on the meteorological data.

6. The sprinkler system of claim 1, wherein the plurality of sprinklers comprises a first sprinkler comprising a base and the nozzle of the first sprinkler is movable relative to the base between:
a first orientation in which the nozzle faces a first direction away from the base; and
a second orientation in which the nozzle faces a second direction away from the base that is different than the first direction.

7. The sprinkler system of claim 6, wherein the controller is further operable to predict airborne particle migration, and wherein the controller is to move the nozzle of the first sprinkler from the first orientation to the second orientation based on a prediction of airborne particle migration.

8. The sprinkler system of claim 1, wherein the controller is further operable to selectively transition the plurality of sprinklers from the second state back to the first state based on the value of the parameter of airborne particles.

9. The sprinkler system of claim 1, wherein the controller is a system controller, and wherein the plurality of sprinklers includes a first sprinkler, comprising:
a control valve fluidically coupled to the nozzle, wherein in the first state, the control valve blocks fluid flow to the nozzle, and wherein in the second state, the control valve permits fluid flow to the nozzle; and
a sprinkler controller to transition the nozzle between the first and second states based on communication from the system controller.

10. The sprinkler system of claim 1, wherein the plurality of sprinklers comprises a first sprinkler, and wherein the nozzle of the first sprinkler comprises an atomizing nozzle.

11. A method, comprising:
sensing, with a sensor, a parameter of airborne particles; and
selectively transitioning, with a controller, a plurality of sprinklers from a first state to a second state based on a value of the parameter of airborne particles, wherein in the first state, a nozzle of at least one of the plurality of sprinklers abstains from spraying a fluid, and wherein in the second state, the nozzle of the at least one of the plurality of sprinklers sprays a fluid.

12. The method of claim 11, wherein in the second state, the nozzle sprays fluid at a first rate, and wherein the method further comprises selectively transitioning, with the controller, the plurality of sprinklers from the first or second state to a third state based on the value of the parameter of airborne particles, wherein in the third state, the nozzle of the at least one of the plurality of sprinklers sprays fluid at a second rate that is different than the first rate.

13. The method of claim 11, further comprising receiving meteorological data, and wherein selectively transitioning the at least one of the plurality of sprinklers from the first state to the second state is further based on the meteorological data.

14. The method of claim 11, wherein the plurality of sprinklers includes a first sprinkler comprising a base, and wherein the method further comprises moving the nozzle of the first sprinkler relative to the base from a first orientation in which the nozzle faces a first direction away from the base to a second orientation in which the nozzle faces a second direction away from the base that is different from the first direction.

15. The method of claim 14, further comprising predicting, with the controller, airborne particle migration, and wherein moving the nozzle from the first orientation to the second orientation is based on a prediction of airborne particle migration.
